(19) United States
(12) Patent Application Publication
(10) Pub. No.: US 2025/0054478 A1
(43) Pub. Date: Feb. 13, 2025

(54) FACE MASK FOR QUIETENING VOCAL SOUND

(71) Applicant: Gerd BIRZELE, Munchen (DE)

(72) Inventor: Gerd BIRZELE, Munchen (DE)

(21) Appl. No.: 18/720,148

(22) PCT Filed: Dec. 16, 2022
(86) PCT No.: PCT/EP2022/086360

§ 371 Date: Jun. 14, 2024

(30) Foreign Application Priority Data
Dec. 17, 2021 (DE) 10 2021 133 668.6

(51) Int. Cl. G10K 11/162

(52) U.S. Cl. CPC G10K 11/162

(57) ABSTRACT

Disclosed is a face mask for quietening vocal sound, including a head support for fixing the face mask to the head of a user, and a shell body which is formed in a shell shape in such a way that it can be attached over the mouth and nose region of a user, the shell body having at least one insulating layer which follows the shell shape and consists of an acoustic insulating material, the shell body having at least one breathing channel which extends from an inner opening on a shell inside facing the user, to an outer opening on a shell outside, and the breathing channel extending substantially inside the insulating layer in parallel with the course of the shell shape.

The invention relates to a face mask for quietening vocal sound.

In order to train their abilities and rehearse songs, professional vocalists, and amateur singers practice regularly. In particular when singing in insufficiently sound-insulated rooms, the singing may also be perceived in adjacent rooms or homes. Outdoors, the singing is audible over greater distances, depending on the volume and environment. Since, when singing, volumes of up to 100 dB can be reached, this can be perceived, by affected people, for example cohabitants, neighbors, or walkers, as noise pollution or a disturbance of peace. During the day, volumes of over 55 dB are considered noise pollution, while at night exceeding 40 dB is already classed as noise pollution. In general it is to be assumed that, when rehearsing and performing, singers are not interested in disturbing or inconveniencing other people in an undesired manner, but rather are dependent on singing regularly for performing their job or their hobby. Quietening of vocal sound is also desirable for other applications, too, for example when speaking on the telephone or when speaking in an office environment.

Against this background, the object of the invention is that of providing a device which enables a user of the device to sing and/or speak without creating noise pollution in the process.

This object is achieved according to the invention, in a first aspect, by a face mask for quietening vocal sound, comprising a head support for fixing the face mask to the head of a user, and a shell body which is formed in a shell shape in such a way that it can be attached over the mouth and nose region of a user, the shell body comprising at least one insulating layer which follows the shell shape and consists of an acoustic insulating material, the shell body comprising at least one breathing channel which extends from an inner opening on a shell inside facing the user, to an outer opening on a shell outside, and the breathing channel extending substantially inside the insulating layer in parallel with the course of the shell shape.

Thanks to the head support, the user does not have to press the face mask onto their head by hand, which increases the freedom of movement of the user. Thus, the user can, if desired, sing and play an instrument at the same time. Furthermore, the fixing of the face mask to the head of the user via the head support makes it possible to ensure that the face mask does not slip during use. The head support can comprise connection elements, via which the head support is connected to the shell body, and which preferably allow for a size adjustment of the face mask or the head support, as a result of which the face mask can be adjusted to the head circumference of the user. Furthermore, the head support can be designed to be flexible, in order to be shaped according to the user's head shape. Preferably, the head support is connected to the shell body of the face mask at a plurality of fastening points, such that a contact pressure or a contact force of the face mask can be distributed uniformly on the user's head.

The shell body of the face mask according to the invention is in particular designed to quieten or muffle sound, and thus ensures the primary function of the face mask. In particular due to the formed shell shape, the shell body can completely cover the mouth and nose region of the user during use of the face mask. The shell body preferably extends over the user's nose and can furthermore surround the bridge of the user's nose. Alternatively, the shell shape surrounds only the mouth and a lower portion of the nose, to just above the tip of the nose. In addition to the user's mouth, the shell body of the face mask can cover the cheeks and the chin, and finish at the base of the neck.

The described configuration of the face mask ensures that vocal sound generated when singing propagates in the user's immediate surroundings only quietened. Furthermore, the shell body is designed such that a freedom of movement of the mouth and jaw that is sufficient for singing is ensured, and that the generated vocal sound can propagate within the face mask.

A pronounced quietening effect is achieved in particular in that the shell body comprises at least one acoustic insulating layer, it being possible for said layer to extend over the entire shell body. The acoustic insulating layer can preferably consist of foam, particularly preferably of open-pored foam, which is formed in particular on the shell inside, i.e. the side facing the user. The vocal sound is absorbed at the surface of the shell inside of the acoustic insulating layer, as a result of which sound reflections are reduced and an acoustic pattern produced by the singing, in the interior of the shell body of the face mask, is optimized. Furthermore, it is conceivable for the shell inside of the acoustic insulating layer to be formed having stud-like and/or pyramid-like structures, in order to reinforce the reduction of the sound reflection and to achieve a pronounced sound-absorbing effect. If a plurality of insulating layers is formed, these can either be produced from the same acoustic insulating material or can comprise different materials, for example in order to form intermediate layers having specific properties.

At this point, it should be noted that the face mask according to the invention is suitable not only for quietening vocal sound but rather that the face mask also fulfils its function in the case of speaking. For example, it may be desirable to quieten vocal sound during a telephone call and/or a meeting, if this is conducted in the presence of other people, for example in an open-plan office, without these people being disturbed.

Furthermore, the shell body comprises at least one breathing channel which is integrated in the face mask, and which is designed to allow for inhalation and exhalation during use of the face mask. For this purpose, the breathing channel extends between an inner opening and an outer opening, which are arranged in each case on the shell inside and on the shell outside, respectively, of the face mask. In order to prevent vocal sound penetrating through the breathing channel of the face mask to an undesired extent, in particular the inner wall of the breathing channel can comprise a sound-absorbing layer, for example an open-pore soft foam, which results in a sound-absorbing effect. Consequently, the breathing channel can achieve the effect of a passive absorption muffler. The sound-absorbing effect can furthermore be increased by barriers, for example longitudinal cassettes, studs, or pyramids, which can be arranged inside the breathing channel, such barriers in general also increasing the breathing resistance.

Furthermore, the breathing channel can comprise at least one channel redirection for quietening the vocal sound. Within the meaning of the present invention, a channel redirection is in particular understood to mean at least one bend of the breathing channel or at least one change indirection of the course of the breathing channel, over a predetermined region of the breathing channel. A channel redirection of this kind can be designed in such a way that there is no geometrically straight line, via which the vocal sound can propagate undamped through the breathing channel, from a start of the course of the channel redirection to an end of the course of the channel redirection. On account of the channel redirection, the vocal sound is reflected at the inner wall of the breathing channel, and in particular reflected back counter to its original propagation direction. Consequently, the effect of a reflection muffler occurs, in which a sound-damping effect is produced by interferences of soundwaves traveling back and forth. It is likewise conceivable that the breathing channel may also be designed as an active muffler, in addition or alternatively to its function as a passive muffler. For this purpose, the breathing channel can for example comprise a device which is capable of producing specific active noise control, according to the vocal sound to be quietened. In this case, interferences are formed, which can attenuate the vocal sound to be muffled (“active noise cancelling”).

According to the invention, the breathing channel extends substantially inside the insulating layer in parallel with the course of the shell shape. In this case, the course of the shell shape is defined by the extension of the shell body of the face mask from the nose or a nose region, via the mouth and cheek region, to the chin or a chin region, and optionally to the base of the user's neck. Accordingly, the surface of the shell body can be designed to be curved or bent once or multiple times. The course of the insulating layer is in particular specified by the course of the shell body. Within the insulating layer, the breathing channel now extends along the shell body or the shell shape, having at least one change in direction in the process. In order to produce the parallel nature of the course of the breathing channel with respect to the course of the shell shape, the breathing channel already has a first change in direction immediately after its start, at the inner opening. The described design of the breathing channel in particular has the advantage that sound-insulating effects can be produced over the entire extension of the breathing channel, and thus the effectiveness of the face mask according to the invention is improved.

As already mentioned, in the face mask according to the invention both sound-quietening effects and also sound-muffling effects can occur, sound-quietening, also referred to as sound-insulation, being understood to be the suppression of the sound propagation into adjacent rooms by means of sound reflection, while in the case of sound-muffling impairment of the sound propagation is produced by sound absorption.

In order to further improve the quietening effect of the breathing channel, in a preferred embodiment of the face mask according to the invention it can be provided that the breathing channel comprises at least one channel redirection, which, in addition to a change in direction specified by the shell shape, has at least one further change in direction. The channel redirection mentioned here, or the change in direction caused by the channel redirection, can in particular be a second change in direction, which can follow the abovementioned first change in direction, proceeding from the inner opening of the breathing channel to the outer opening of the breathing channel. In the course of the second change in direction, the breathing channel that comprises channel redirections can be aligned with the outer opening on the shell outside, in order to keep the flow resistance of the breathing air as low as possible. Alternatively, the breathing channel can also be designed without a channel redirection and/or change in direction, i.e. the breathing channel can extend substantially straight and horizontally. Such an alternative design of the breathing channel may be preferred inter alia for use of the face mask when speaking on the telephone.

Optionally, the at least one channel redirection of the breathing channel of the face mask according to the invention can comprise two alternating changes in direction. In this case, the two changes in direction can relate to an alternating course of the breathing channel, a first sub-portion of the breathing channel extending along the shell shape, during the first change in direction, and a second sub-portion of the breathing channel extending to the outer opening on the shell outside, during the second change in direction. A course of this kind makes it possible for the sound-insulating effect of the breathing channel to be increased, since the vocal sound is reflected more during its propagation through the breathing channel.

The object is furthermore achieved according to the invention, in a second aspect, by a face mask for quietening vocal sound, comprising a head support for fixing the face mask to the head of a user, and a shell body which is formed in a shell shape in such a way that it can be attached over the mouth and nose region of a user, the shell body comprising at least one insulating layer which follows the shell shape and consists of an acoustic insulating material, the shell body comprising at least one breathing channel which extends from an inner opening on a shell inside facing the user to an outer opening on a shell outside, and at least one support portion being formed on an edge region of the shell body, which support portion contacts a cheekbone region of the user when the face mask is worn, such that a contact pressure of the face mask can be diverted to the user via the support portion.

An important inventive concept of the second aspect is therefore that the shell body of the face mask comprises at least one support portion at an edge region. In general, the lateral ends of the shell body of the face mask according to the invention are considered the edge region, which ends are formed on the nose region, the cheek region, the chin region or jaw, the cheekbone region, and/or, if the shell body extends as far as the base of the user's neck, the region of the base of the user's neck.

The support portion is designed to divert the contact pressure or the contact force of the shell body of the face mask, which is generated inter alia by the head support, when the face mask is worn, and is directed onto the user's face, via the support portion to the cheekbone region of the user. For this purpose, when the face mask is worn the support portion preferably rests directly on the cheekbone region of the user. An arrangement of this kind increases the freedom of movement of the jaw, the region of the mouth, and the nose, of the user when singing or speaking during use of the face mask, since the contact pressure of the shell body can now be diverted mainly via the support portion. Consequently, less pressure is applied to the user's face via the edge regions of the shell body adjacent to the user's jaw, mouth, and nose. Since the mobility or freedom of movement of the cheekbone region plays only a subordinate role during singing, the user is barely impeded by the contact pressure acting on the cheekbone region. Thus, on account of the high degree of freedom of movement of relevant parts of the face when the face mask according to the invention is worn, both signing and breathing through the mouth and/or nose can be simplified.

In a preferred embodiment of the face mask according to the invention, two support portions are formed on the shell body, which support portions are arranged symmetrically to one another with respect to a plane of symmetry extending vertically through the face mask. Forming two support portions that are arranged symmetrically relative to one another allows for uniform transfer of the contact pressure of the shell body onto the face of the user, it being possible in each case for one support portion to be associated with a cheekbone region of the user. In this connection, the symmetrical arrangement of the two support portions is advantageous in particular if the face mask comprises a shell body that consists of two symmetrical halves with respect to said plane of symmetry. Alternatively, however, the face mask can also comprise two or more support portions, which do not have any symmetrical relationship to one another.

Furthermore, the shell body of the face mask can comprise a substantially horizontally extending upper edge, which is delimited along the main extension direction thereof by the two support portions. In this case, the upper edge can in particular be arranged adjacently to the bridge of the user's nose, such that the shell body of the face mask on the one hand covers the user's nostrils, and on the other hand the face mask ends below the user's eyes, in the vertical direction or height direction, in order not to impair the user's sight when wearing the face mask. Preferably, the upper edge is designed to be substantially horizontally extending, such that the user can for example also wear glasses, together with the face mask. In addition, it can be provided for the upper edge to be curved or hollowed, at least in portions, and thus matched to the shape of the human nose.

In a further embodiment of the face mask according to the invention, the support portion can be designed in such a way that the face mask can be displaced vertically, relative to the user's cheekbone region, when worn. In other words, the support portion can have a substantially smooth surface, which rest on the cheekbone region of the user when the face mask is worn, and can allow for sliding of the face mask over the cheekbone region when the face mask is displaced relative to the cheekbone region, in particular in the vertical direction. In this case, a displacement of the face mask can be caused for example by a jaw movement of the user, in the course of which the jaw presses on the lower region of the insulating layer of the shell body and thus displaces the face mask downwards by a few mm to cm, viewed in the vertical direction. In this connection, the support portion can act in the manner of a floating bearing and can thereby ensure the displaceability or shiftability of the face mask relative to the cheekbone region of the user. As a result, it is possible in particular the pressure generated by the face mask, which acts on the jaw during singing, to be reduced.

It can optionally also be provided that the support portion is surrounded by the insulating layer, the support portion having a greater stiffness and/or a greater thickness than regions of the insulating layer neighboring the support portion. In this case, in particular the insulating layer including the support portion can be formed in one piece, such that the production of the shell body is simplified. This means that the support portion can also consist of foam, preferably of open-pored foam. It is alternatively also conceivable, however, for the support portion to be produced from a different material from the insulating layer.

With regard to the production of the insulating layer, it is furthermore conceivable that the insulating layer is formed not in one piece, but rather in multiple parts, in particular in two or three parts. Thus, for example, a first part of the insulating layer covered by an outer layer of the shell body can be provided, which is connected to a second part of the insulating layer, for example by adhesion or sewing. In this case, the second part of the insulating layer can constitute a transition region between the shell body and the user's face, and thus comprise inter alia the contact surfaces of the insulating layer, including the support portion. In this way, it is possible to provide a multi-part insulating layer which comprises different materials. Thus, for example, the first part of the insulating layer could comprise a material having pronounced sound-insulating properties, while the second part of the insulating layer comprises a material which is particularly well suited for transmitting the contact pressure of the shell body to the user's face.

In order to focus the transmission of the contact pressure of the face mask to the user's face on the support portion, it can furthermore be provided for the support portion to be designed having a greater stiffness compared with any other contact surfaces of the insulating layer which rest on the user's face when the face mask is worn. In order to increase the stiffness of the support portion, this can for example be designed having a greater thickness or strength than the remaining contact surfaces, with respect to the width direction of the shell body, in particular the remaining contact surfaces in the upper region of the shell body. As a result, a support portion can, if desired, contact a plurality of cm², preferably 0.5 to 8 cm², particularly 1 to 4 cm², of a cheekbone region of the user. Alternatively or in addition, an increased stiffness of the support portion can also be achieved in that said portion is produced using a material that is stiffer or harder compared with the remaining contact surfaces of the insulating layer.

Furthermore, it should be explicitly noted, at this point, that the term “cheekbone region” in connection with the face mask according to the invention relates to the user's cheekbone but can optionally also include the user's temporal bone. The face mask according to the invention, according to the second aspect, can thus comprise at least one support portion which contacts or rests on the user's temporal bone when the face mask is worn. Accordingly, all the features and advantages mentioned above with respect to the interaction between the support portion and the user's cheekbone region, in particular with respect to the transmission of the contact pressure, is also applicable for the interaction between the support portion and the cheekbone and between the support portion and the user's temporal bone. A face mask of this kind is in particular wider, with respect to the contact surfaces of the insulating layer in an upper part of the shell body, than a face mask according to the first aspect. The contact pressure of the shell body can thus be diverted to the user both substantially frontally, i.e. primarily via the cheekbone and in addition in the region of the jaw, the nose, the cheek, and under the eyes, and also laterally, i.e. via the temporal bone. The support portion can furthermore be designed to rest, at least in portions, on the cheekbone and the temporal bone of the user of the face mask. Alternatively, it is also conceivable for the support portion to rest either on the cheekbone or on the temporal bone.

According to a third aspect, the object is achieved according to the invention by a face mask for quietening vocal sound, comprising a head support for fixing the face mask to the head of a user, and a shell body which is formed in a shell shape in such a way that it can be attached over the mouth and nose region of a user, the shell body comprising at least one insulating layer which follows the shell shape and consists of an acoustic insulating material, the shell body comprising at least one breathing channel which extends from an inner opening on a shell inside facing the user, to an outer opening on a shell outside, and at least one sealing lip being arranged on the shell inside.

The sealing lip, which constitutes an important feature of the face mask according to the invention, according to the third aspect, can in particular be provided for limiting or adjusting the cavity volume of the face mask on the shell inside. For this purpose, one or more sealing lips can be arranged at different regions of the shell inside and can extend in the direction of the cavity of the shell body. In general, a sealing lip can be oriented according to the course of the shell body, for example in parallel with the course thereof, and in the process have an elongate shape. A sealing lip preferably extends from the shell inside towards the user, it also being conceivable for at least one sealing lip to be formed on the shell inside, which lip does not extend in the direction towards the user's face, but rather away from the user.

Even if one or more sealing lips can be provided at different regions on the shell inside, the arrangement thereof at the edge regions of the shell body is preferred, since overlapping of a sealing lip with an opening of the breathing channel can be prevented thereby. Thus, a sealing lip can be formed for example in or around the nose region, on the shell inside of the face mask. Furthermore, two sealing lips can be provided symmetrically to one another, with respect to their respective arrangement on the shell inside, such that for example a first sealing lip is arranged on the left-hand side of the nose region, and a second sealing lip is arranged on the right-hand side of the nose region.

In an optional embodiment of the face mask according to the invention, the sealing lip can be designed in such a way that it contacts the user's face when the face mask is worn. The sealing lip can thus fulfil the function of a contact surface, as a result of which the contact pressure generated by the shell body is transmitted to the user's face via a sealing lip. However, the contact pressure of the shell body is preferably transmitted to the user's face, via the sealing lip, only slightly, such that although on the one hand a uniform distribution of the contact pressure over the entire shell body can take place, on the other hand the parts of the face relevant for singing and breathing are not impaired by the sealing lip with respect to their freedom of movement. Furthermore, it is also conceivable for the sealing lip to be of a shape that tapers in the direction of the user. The user's singing experience can also be positively influenced by the formation of the sealing lip, since, on account of the shape thereof, the sealing lip can deform relatively easily, and thus adjust to the user's face shape, in the course of contacting of the user's face. In particular, the sealing lip may be only a few mm thick, in particular between 1 and 10 mm thick, and thus relatively thin, as a result of which the deformability of the sealing lip is further promoted.

Furthermore, the formation of the sealing lip on the shell inside can have a positive effect on the sound-insulating properties of the face mask, since, on account of the contact of the sealing lip with the user's face, an additional barrier results for the vocal sound produced when singing. This barrier is in particular capable of insulating the propagation of the vocal sound in regions that are arranged behind the sealing lip. Depending on the arrangement of the sealing lip, it is furthermore possible for the sealing lip to reflect back the produced vocal sound, counter to its original propagation direction, such that a sound-insulating effect is produced. Alternatively, it is also conceivable for the sealing lip to not or to only partially contact the user's face when the face mask is being worn.

In order to simplify the production of the face mask according to the invention, it may be advantageous for the sealing lip to be included in the insulating layer. Optionally, the sealing lip can furthermore comprise the acoustic insulating material. Thus, the insulating layer together with the sealing lip can in particular be formed in one piece and/or be produced in a common manufacturing step. Furthermore, the quietening effect of the sealing lip can be improved, in that said lip comprises the acoustic insulating material. However, it may optionally also be preferred to produce the sealing lip from a different material compared with the acoustic insulating material, for example in order to provide a sealing lip having greater elasticity or also greater stiffness than the insulating layer.

Furthermore, at least one free portion of the acoustic insulating material can be formed adjacently to a sealing lip, on the insulating layer of the shell body, which free portion is spaced apart from the user's face when the face mask is worn. In other words, owing to a protruding sealing lip, a free portion of the acoustic insulating material can be defined, which directly adjoins the corresponding sealing lip and does not touch or does not contact the user's face when the face mask is worn, i.e. does not constitute a contact surface. A free portion of this kind ensures that the contact surfaces of the face mask on the user's face do not become too large, and thus in particular that there is freedom of movement of the parts of the user's face relevant for singing and breathing that is as unrestricted as possible. The static friction between the shell body and the user's face, which in particular affects the displaceability of the face mask relative to the user's face, would also be increased to an undesired extent by forming particularly large contact surfaces. Increased static friction would in turn have a disadvantageous effect on the mobility of the parts of the face relevant for singing and breathing.

If desired, the free portion or the acoustic insulating material in the region of the free portion may also be designed to be thinner than the surrounding acoustic insulating material of the insulating layer, in order to ensure that the free portion does not rest on the user's face, even in the case of particularly high contact pressures.

In a further embodiment of the face mask according to the invention, at least one sealing lip can be arranged so as to extend substantially horizontally, on the shell inside, and can contact the user's nose when the face mask is worn, and/or at least one sealing lip can be arranged so as to extend substantially vertically, on the shell inside. The sealing lips can in particular be arranged in such a way that contact between the insulating layer and the nose region and the cheek region of the user's face is established thereby, as a result of which the face mask has a pronounced quietening effect in the corresponding regions. Furthermore, a sealing lip can have at least one bend, for example in order to be particularly favorably deformable, according to the user's face shape, when the face mask is worn.

It should be explicitly noted, at this point, that all the features, effects and advantages described with respect to the face mask according to the invention can also be applicable to the face mask according to the invention, of the second aspect, and/or the face mask according to the invention, of the third aspect, and vice versa. The features of the three aspects described above can thus be advantageously combined with one another. Furthermore, possible embodiments of the invention are described in the following, which can in each case represent advantageous developments for each of the three aspects of the invention.

As already mentioned, it may be advantageous, in particular for forming a sound-insulating effect within the breathing channel of the face mask according to the invention, for the acoustic insulating material to comprise a sound-absorbing surface in the region of an inner wall of the breathing channel. In this case, in addition or alternatively to open-pored soft foam, other open-pored structures can also be used, for example felting and/or non-woven fabrics. It is also possible for the inner wall of the breathing channel to also comprise dense or non-porous materials. Such materials can in particular produce a sound-absorbing effect if they comprise stud-like and/or pyramid-like structures on their surface. Analogously to the breathing channel, in particular the sealing lips arranged on the shell inside can also be provided having a sound-absorbing surface of this kind.

In a further embodiment of the face mask according to the invention, the inner opening can be arranged adjacently to a mouth region of the user of the face mask, and the outer opening can be arranged adjacently to a chin region, a cheek region, or a nose region of the user of the face mask. A positioning of the inner opening in the direct vicinity of the mouth region of the user can be expedient in particular if breathing takes place primarily through the mouth, during singing. Such positioning of the inner openings can have an advantageous effect on the air circulation or the CO₂ exchange between the interior of the shell body and the surroundings, as a result of which in particular the additional dead space volume resulting from wearing the face mask can be reduced. Depending on the design of the face mask according to the invention, and the course of the breathing channel, the arrangement of the outer opening on the shell body adjacently to the chin region, the cheek region or the nose region of the user may be advantageous, this arrangement depending substantially on the user's face shape. Furthermore, for forming the breathing channel it may also be advantageous to arrange the outer opening adjacently to the region of the base of the neck of the user.

Moreover, the inner opening can be arranged on the shell body so as to be horizontally offset relative to the mouth region of the user of the face mask according to the invention. An arrangement of this kind in particular makes it possible to ensure that the vocal sound produced does not pass directly from the mouth region into the breathing channel, but rather primarily strikes the acoustic insulating material of the insulating layer, at which the sound-absorbing effect of the face mask is particularly pronounced. This arrangement can furthermore have an advantageous effect on the reduction of murmurs, which can occur in particular when inhaling and exhaling via the breathing channel. Furthermore, the arrangement of the inner openings that is offset horizontally with respect to the user's mouth region can contribute to it being possible to achieve a design of the breathing channels that is favorable for flow. In particular compared with an inner opening which is directly opposite the user's mouth region, in this case soft radii of the breathing channel can be produced, whereupon the breathing air does not have to be sharply deflected about 90° directly after exhalation, in order to be able to be conducted downwards to the chin region or the base of the neck of the user. Alternatively, it is also conceivable for the breathing channel to be arranged so as to be vertically offset relative to the user's mouth region.

In order to additionally improve the sound-absorbing effect of the breathing channel, the outer opening on the shell body can be arranged at an edge region of the shell body. An outer opening arranged in this way has the advantage that channel redirections or the changes in direction of the breathing channel can be formed over a maximum extension of the breathing channel. Arranging the outer opening in the edge region of the face mask can furthermore prevent too large a recess of the outer layer, in particular a breach of the outer layer, in a central portion, such that the outer opening does not too severely impair the insulating effect of the outer shell.

In a preferred embodiment, the face mask according to the invention can comprise a plurality of breathing channels, preferably two breathing channels. In this case, it is conceivable for the plurality of breathing channels to be integrated in the insulating layer, completely or at least in part. Compared with an individual breathing channel, forming a plurality of breathing channels can improve the air circulation between the interior of the shell body of the face mask and the surroundings. If the shell body comprises exactly two breathing channels, then in each case one inner opening and in each case one breathing channel can be arranged horizontally on either side, with respect to the user's mouth region, it being possible for the two channels to be designed to be offset to the left and right, relative to the mouth region. It has furthermore been shown that, in the case of two breathing channels being formed in the face mask according to the invention, the lowest possible breathing resistance can be achieved, together with the greatest possible insulating effect. It has also been shown that two or more breathing channels can have a reducing effect on the occurrence of suction effects, as a result of which murmurs can furthermore also be suppressed, which are produced in the course of inhaling and exhaling. Alternatively, the two breathing channels and the associated inner openings can also be arranged so as to be vertically offset relative to one another.

If desired, the face mask according to the invention can comprise an outer layer which is formed of a different material from the insulating layer. In this case, it can in particular be provided for the outer layer, which consequently represents the shell outside of the shell body, consists of a stiffer material than the insulating layer, in order to provide the face mask with stability. Preferably, the more flexible insulating layer can comprise an open-pored soft foam for sound absorption, while the outer layer can represent a closed layer. Optionally, the outer layer can also be designed to contribute to the sound absorption of the face mask. This can inter alia be achieved in that the outer layer is produced from the same material as the acoustic insulating layer. In general, it is desirable for the material of the outer layer to have a high degree of flexibility, it being possible for the specific weight of the material of the outer layer to be greater than the specific weight of the material of the insulating layer. In order to keep the total weight of the face mask as low as possible, it may further be advantageous for the outer layer to be formed to be as thin as possible, and/or to be formed in a sandwich construction using a lighter material. In addition, the outer layer can also comprise embedded reinforcing elements or filler elements, which are for example produced from fiber composites, in order to increase the strength of the outer layer. It may be particularly preferable for the at least one breathing channel of the shell body to be designed to be open at least in part, with respect to the outer layer. This can in particular reduce the breathing resistance, and furthermore simplify the production of the shell body of the face mask according to the invention, since improved demolding ability can be achieved. In this case, the demolding ability relates to the release of the produced and hardened shell body from molding tools.

Furthermore, the outer layer and the insulating layer can be produced in a sandwich construction and optionally adhesively bonded to one another, in order to rigidly connect the insulating layer to the outer layer. Other connection possibilities, for example via a hook and loop fastener, are also possible in this case. In addition or alternatively, it can be provided that the acoustic insulating layer on the shell outside is formed to be entirely or at least in part closed or not open-pored, in order to make it more difficult for dirt or impurities to settle on the shell outside of the acoustic insulating layer.

Since a singer may well be interested in recording their singing during use of the face mask according to the invention, said face mask may comprise at least one microphone. For this purpose, it can be provided to integrate the microphone in the insulating layer or in the outer layer. Furthermore, the microphone can be removable for cleaning or maintenance. If the face mask according to the invention does not comprise an integrated microphone, then the user of the face mask can, if desired, introduce an external microphone into the interior of the shell body, in order to record their singing.

If desired, the face mask can be used for recording audiobooks or podcasts, for which good and uniform acoustics are desirable and a constant distance between the microphone of the face mask and the mouth of a user is accordingly advantageous. If a plurality of microphones is formed in the face mask, then these are preferably to be arranged in the face mask in such a way that a uniform sound pattern can be recorded. The at least one microphone can furthermore in particular be designed as a MEMS microphone (microelectromechanical system), which advantageously requires particularly little space and has a low power consumption.

In a further embodiment of the face mask according to the invention, this can comprise headphones or be connectable to external headphones, and the face mask can comprise at least one processing unit for processing acoustic signals. This can be provided in order to enable the user of the face mask to perceive their singing without the quietening effects of the face mask. In addition, for processing, storing, and/or transmitting the singing recorded by the microphone, a processing unit, a storage unit, and/or a communications interface can be provided in or on the face mask. The communications interface can in particular be designed to transmit singing, processed into acoustic signals, wirelessly or without cables, for example via Bluetooth, or in a cabled manner, for example via a USB connection or an AUX connection, preferably in real time, such that it can be played back and/or stored on an external device. In this case, it may also be feasible for the signals processed by the processing unit are also stored on the storage unit and are transmitted at any desired point in time to an external device. For this purpose, the processing unit can output the singing, recorded via the microphone, directly to the headphones. Furthermore, it may also be possible to transmit audio signals from external devices to the processing unit of the face mask, if necessary to process then using the processing unit, and subsequently to output them to the user of the face mask via the headphones.

In addition, all the electronic components and in particular the at least one microphone can be connected to the processing unit and a control unit, for example in the form of a digital signal processor, which can be provided adjacently to the microphone, in the shell body. The processing unit and the control unit can be designed to process received acoustic signals, for example to compress them or to change them by means of audio effects. Furthermore, in the case of a plurality of MEMS microphones, the processing unit and the control unit, and their specific arrangement relative to one another, can produced a desired directional characteristic.

In order to ensure the ongoing operation of the described electronic components of the face mask, the face mask according to the invention can comprise at least one battery or at least one accumulator. The battery or the accumulator can be designed to be both chargeable in the face mask via an external power source, and also removable or replaceable. For this purpose, in addition to the conventional electric supply grid, external devices, in particular Smartphones or tablets, can also serve as the external power source, which devices can be able to be coupled to the face mask for example via a USB connection. In addition, it is conceivable that the face mask is designed without a battery or accumulator, and that it can be supplied with power directly via one of said external power sources, during operation. In order to ensure that the electronic components do not consume any power when the face mask is not in use, the face mask can furthermore comprise an ON/OFF switch, which is correspondingly connected to the electronic components.

Since external background noises may be entirely disadvantageous during singing, it is possible for the face mask according to the invention to further comprise at least one sound-insulating device, which is provided at the ear regions of the user and is designed to quieten external acoustic signals. If the face mask comprises integrated headphones, then these can be designed as noise-reducing headphones, these being able to contribute passively to sound insulation via sound-insulating materials, and also being able to use active noise control (“active noise cancelling”) for active noise reduction. If the face mask does not comprise any internal headphones, then the sound-insulating device can be based on purely passively sound-insulating materials and be integrated in the head support. Furthermore, the shell body of the face mask can also be designed to contribute to the reduction of external background noises, in that the insulating layer of the shell body, in addition to quietening vocal sound produced in the interior of the face mask, also suppresses the penetration of external background noises into the face mask. Consequently, the insulating layer and also the sound-insulating device mean that such background noises do not distract the singer during singing, and/or that the quality of the singing recorded by the microphone is not impaired by background noises.

Furthermore, the face mask according to the invention can preferably be designed such that a center of gravity of the face mask, which is arranged as close as possible to the user's face, is set by the ratio between an inner height, an inner width, and an inner depth of the face mask. As a result, the application of force required for wearing the face mask reduces, in such a way that the contact pressure to be applied by the head support is lower and ultimately the wearing comfort of the face mask and the freedom of movement of the user's jaw can be increased. In order to reduce the contact pressure acting on the user's face, the head support can preferably be designed such that the greatest possible fraction of the weight of the face mask can be transmitted to the top of the user's head with a pronounced vertical force absorption by the head support and the connection elements thereof. This means that a lower contact pressure is required in the horizontal direction, in order to fix the face mask to the user's face. In this connection, it should be noted that the contact pressure can be distributed uniformly over a relatively wide contact surface of the shell body on the user's face, such that the wearing comfort of the face mask can be further increased. In this case, the inner height of the face mask relates to the maximum distance, in the vertical direction, between a chin region of the insulating layer and a nose region of the insulating layer. In contrast, the inner width of the face mask relates to the maximum distance, in the horizontal direction, between the two cheek regions of the insulating layer. The inner depth relates to the maximum distance, in the horizontal direction or depth direction, between the insulating layer and the user's face.

Furthermore, the described design of the face mask in particular makes it possible to produce an optimized distribution of the contact pressure exerted by the head support, as a result of which a uniform insulating effect can be ensured over the entire shell body. A sufficiently high degree of freedom of movement of the jaw is particularly important when singing, which freedom of movement is achieved, in the case of the face mask according to the invention, inter alia also in that the face mask can preferably extend over the chin region and as far as the base of the neck of the user.

For this purpose, the face mask according to the invention can have an inner width which corresponds to 0.5 to 1.3 times, preferably 0.6 to 1.2 times, an inside height, or an inner height of the shell body of the face mask. An outer width of the shell body can in particular correspond to 0.75 to 1.95 times, preferably 0.85 to 1.75 times, the inner height of the shell body. Furthermore, the inner depth of the shell body can in particular correspond to 0.15 to 0.75 times, preferably 0.25 to 0.65 times, the inner height of the shell body. The inner width of the shell body can correspond to 1.05 to 2.7 times, preferably 1.15 to 2.6 times, the inner depth of the shell body, and an outer depth, which relates to a maximum distance, in the horizontal plane, between the shell outside and the user's face, can correspond to 0.4 to 0.9 times, preferably 0.5 to 0.8 times, the outer width of the shell body.

In a preferred embodiment of the face mask according to the invention, the face mask can have a cavity volume which is less than 230 cm³, preferably less than 150 cm³. This relates in particular to the fact that the occurrence of shallow breathing during use of the face mask should be prevented. Shallow breathing is understood as inhaling breathing air that has already been used or exhaled, owing to too large a dead space volume, which, in extreme cases, can lead to carbon dioxide poisoning. The cavity volumes of the face mask can therefore be designed such that the user of the face mask is continuously supplied with fresh air, via the breathing channel, while singing, while at the same time a pronounced quietening effect is ensured. In this case, a cavity volume or cavity is considered to be the volume, spanned by the shell body of the face mask, between the shell body and the user's face, which can influence the user's breathing, including the volume of the breathing channel. Consequently, wearing the face mask enlarges the dead space volume by the cavity volume of the shell body, and therefore a cavity volume of the face mask that is as small as possible is preferred.

As already mentioned, it is in particular advantageous if the breathing resistance occurring during use of the face mask according to the invention is as low as possible, since an increased application of force, caused by labored breathing, can have a negative effect on the singing performance of the user of the face mask. In extreme cases, an excessive breathing resistance can even cause damage to health in the lungs and at the vocal cords. In the case of breathing resistances that are too high, there is also a risk of the state of unconsciousness occurring on account of an ongoing hypoxemia of the bloodstream. It should furthermore be noted that the size of the inner volume of the face mask affects the breathing resistance, it being possible for a smaller inner volume to result in an increase in the breathing resistance. Therefore, the face mask can advantageously be designed in such a way that it has an inhalation resistance of less than 1.2 mbar, preferably less than 0.5 mbar, and an exhalation resistance of less than 1.7 mbar, preferably less than 1 mbar. The stated values relate to measurements made on the basis of a test arrangement and test parameters, taking into account the DIN standard EN 149.

The face mask according to the invention will be described in greater detail in the following, on the basis of embodiments and with reference to the accompanying drawings, in which:

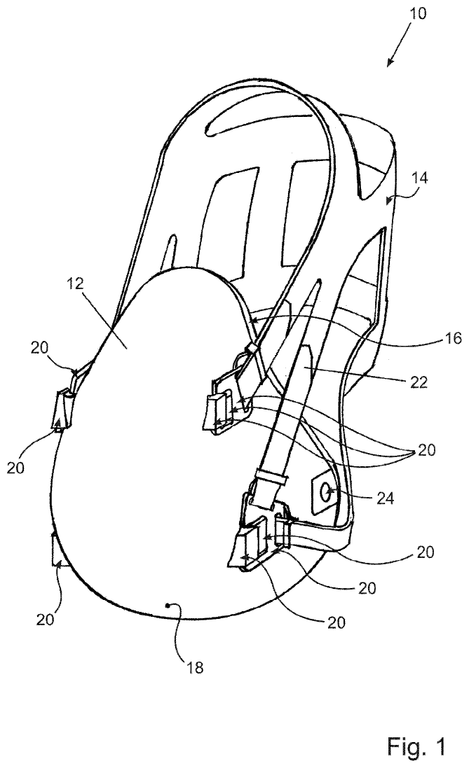

FIG. 1 is a perspective view of a first embodiment of a face mask according to the invention, comprising a head support;

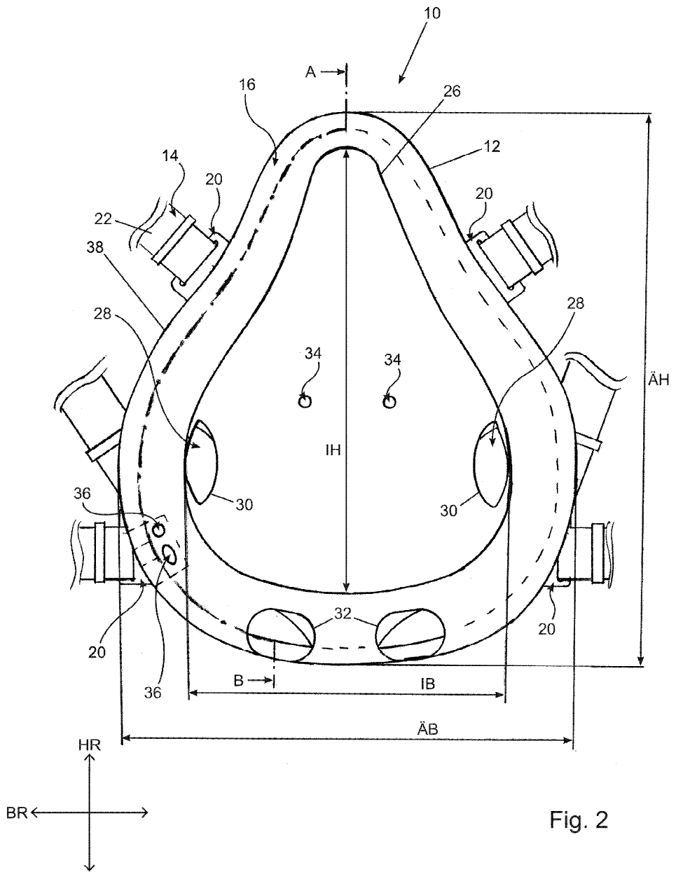

FIG. 2 is a rear view of the first embodiment of the face mask according to the invention;

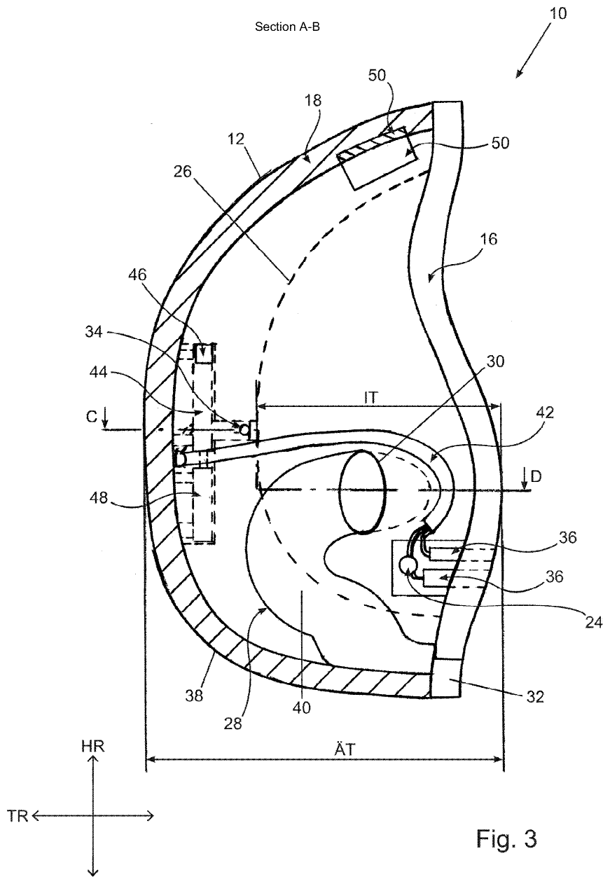

FIG. 3 is a lateral cross-section of the first embodiment of the face mask according to the invention, along the line A-B shown in FIG. 2;

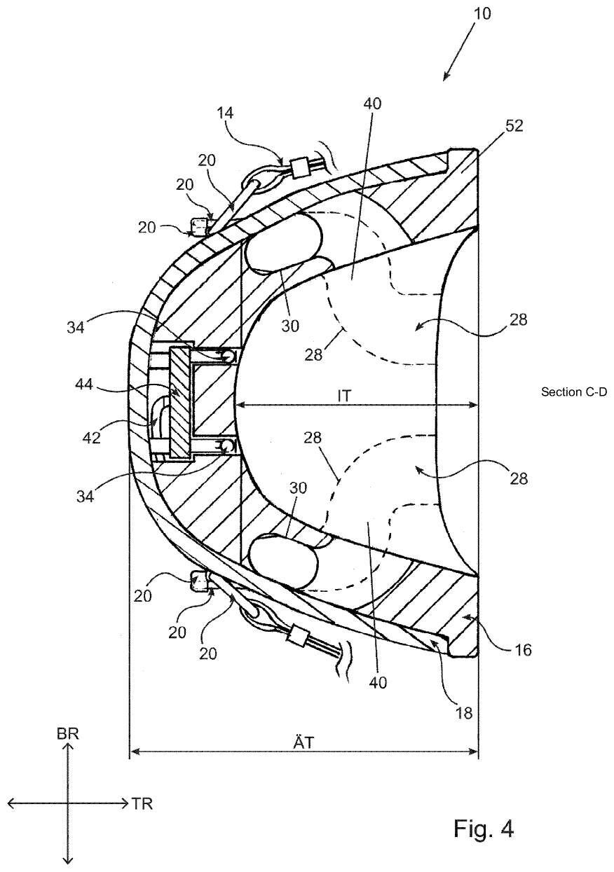

FIG. 4 is a plan view of a cross-section of the first embodiment of the face mask according to the invention, along the line C-D shown in FIG. 3;

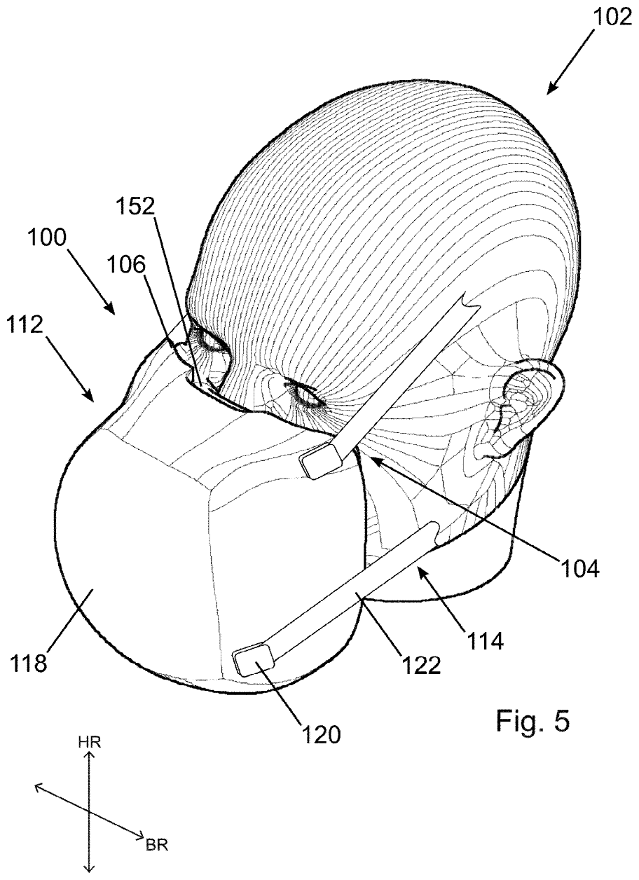

FIG. 5 is a perspective view of a second embodiment of the face mask according to the invention, also showing a user of the face mask;

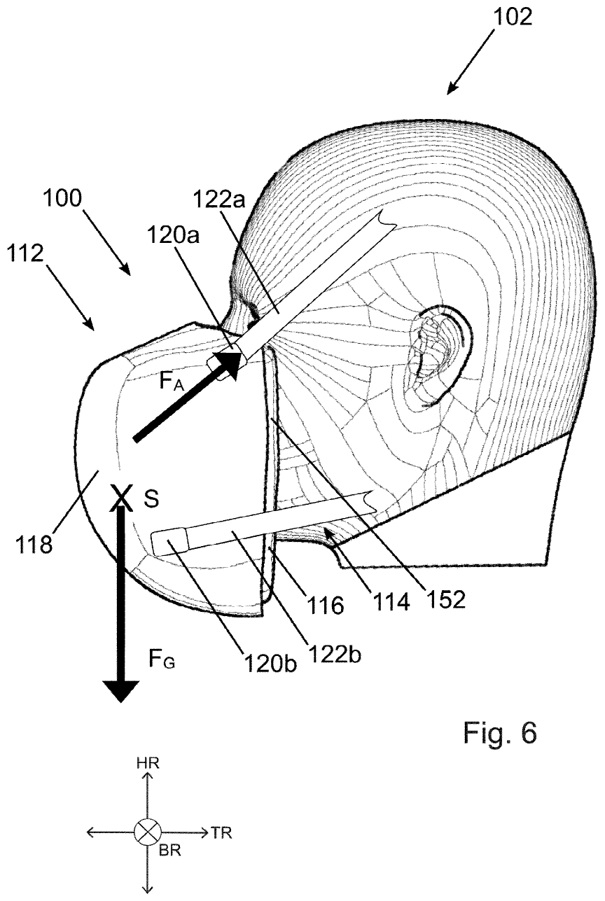

FIG. 6 is a side view of the second embodiment of the face mask according to the invention;

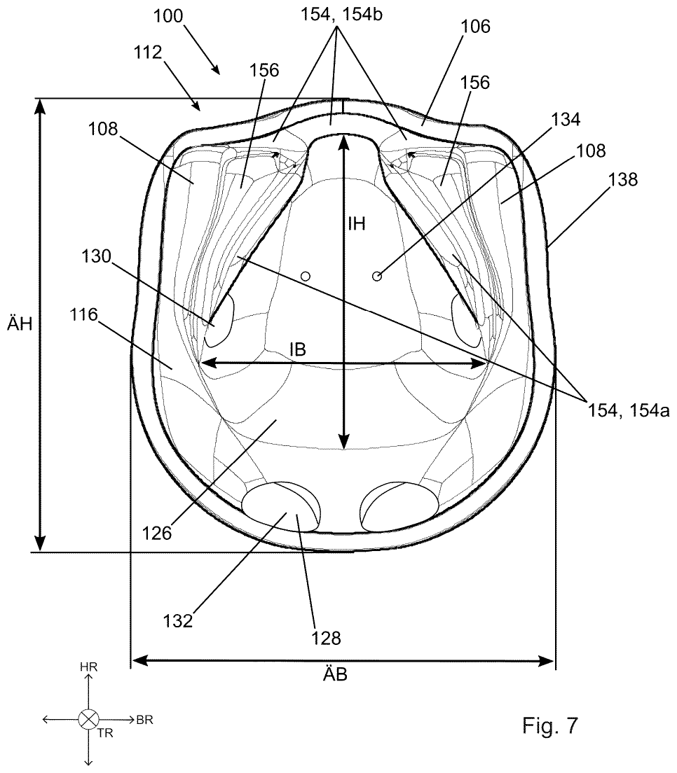

FIG. 7 is a rear view of the second embodiment of the face mask according to the invention;

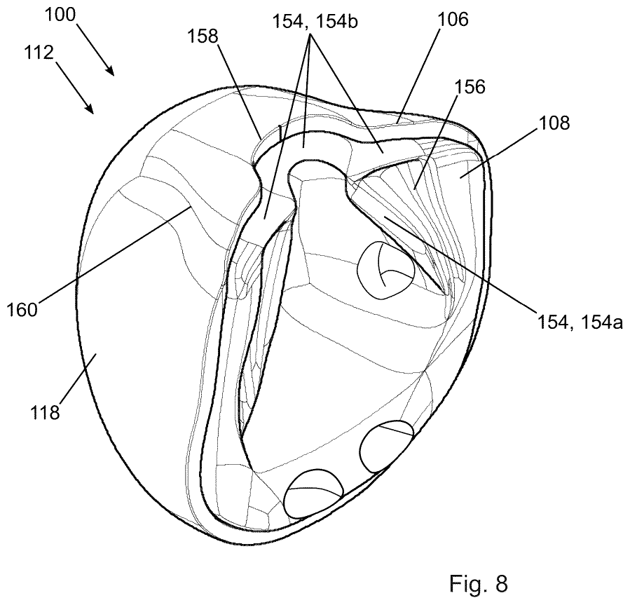

FIG. 8 is a perspective view of the second embodiment of the face mask according to the invention; and

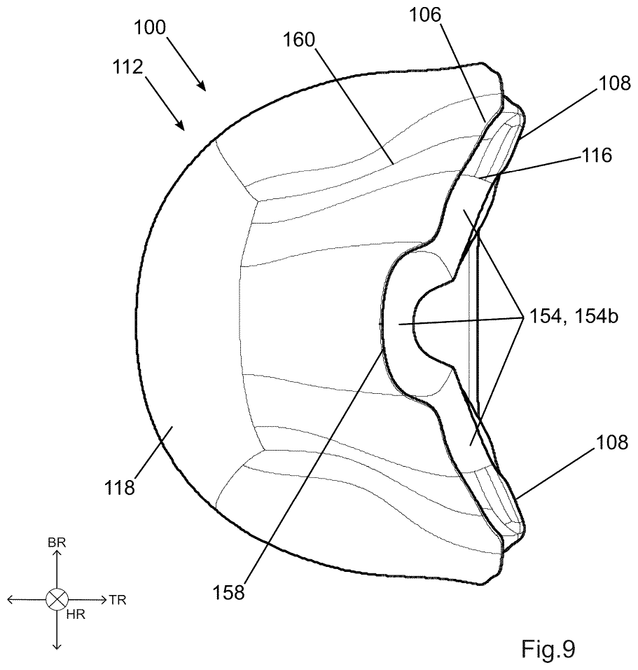

FIG. 9 is a plan view of the second embodiment of the face mask according to the invention.

In FIG. 1, a first embodiment of a face mask according to the invention for quietening vocal sound is provided in a general manner with the reference sign 10. In this case, the face mask 10 comprises a shell body 12 and a head support 14, the shell body 12 comprising an insulating layer 16 on its inner side, which faces the face or the mouth and nose region of a user, and comprising an outer layer 18 on its outer side. Both the insulating layer 16 and the outer layer 18 follow the shell shape of the shell body 12. In FIG. 1, the insulating layer 16 is visible only at the edge regions of the shell body 12, at which it also serves, in addition to its primary function of sound insulation, as padding, in order to increase the wearing comfort of the face mask. The insulating layer 16 and the outer layer 18 can be produced from an identical material, but preferably the insulating layer 16 is formed of an acoustic insulating material in the form of a flexible soft foam, which is designed to be open-pored for sound absorption, but may optionally also be closed-cell or not open-pored at the edge regions thereof, while the outer layer 18 comprises a more robust, continuous plastics material, compared with the soft foam of the insulating layer 16. It is not shown in FIG. 1, but is also possible, for at least one intermediate layer to be arranged between the insulating layer 16 and the outer layer 18, which intermediate layer serves for example for weight regulation and/or may have additional insulating properties. In this case, it is conceivable that the strength of the outer layer is reduced, for weight reduction, but the face mask 10 has identical insulating properties by virtue of the inserted intermediate layer, which can also be designed to be sound-absorbing.

In FIG. 1, by way of example, a plurality of connection devices 20 is provided on the outer layer 18 of the shell body 12, which devices can be designed for example in the form of pockets, caps, rings, and/or eyes. In this case, the number of connection devices 20 is not limited to the number shown in FIG. 1 and can be varied. The connection devices 20 are designed to engage with connection elements 22 of the head support 14, which can be formed for example on one side, in the form of loops, in order to fix the head support 14 on the shell body 12. Since the connection elements 22 can in particular be provided to be adjustable in size, a user can set the head support 14 of the face mask 10 to a desired size, in order to generate a sufficiently high contact pressure. The head support 14 can be produced from a flexible material, such that it matches the face shape of a user. Robust reinforcing elements, for example in the form of plastics parts, can also be provided on or in the head support 14, in order to increase the stability of the head support 14. It is also conceivable for the head support 14 to be formed as an integral piece, and furthermore to also be adjustable in size, such that the face mask 10 can also be adjusted via the head support 14, in addition or alternatively to the connection elements 22. In this case, the head support 14 can completely surround the head of the user and/or extend at least in part over the shell body 12, such that connection devices 20 and connection elements 22 can be saved and the force absorption of the weight of the face mask 10 can be better distributed. A head support 14 of this kind could be produced from a fabric for example.

Furthermore, FIG. 1 shows an ON/OFF switch 24, which is arranged at an edge region of the cheek region of the face mask 10 according to the first embodiment, the position thereof not being limited to the position shown in FIG. 1. The ON/OFF switch 24 enables a user to set the operating state of the face mask 10 and for example to switch on and off electronic components of the face mask 10, which will be described below. In order to optically visualize the operating state and optionally the state of charge of a battery or an accumulator of the face mask 10, the ON/OFF switch 24 can comprise corresponding illuminants, for example an LED. The face mask 10 can comprise further switches (not shown in FIG. 1), which are designed for example to regulate the volume of the headphones or to activate a wireless connection to external devices.

FIG. 2 is a rear view of the first embodiment of the face mask 10 according to the invention, showing the shell inside 26 of the face mask 10 facing the user. Furthermore, FIG. 2 illustrates the extension of the shell body 12 of the face mask 10 along the height direction HR and along a width direction BR. Here, the shell body 12 has an inner height IH which, extending along HR is defined as the maximum distance between the opposing shell insides 26 of the shell body 12, an outer height ÄH, which, extending along HR, is defined as the maximum distance between the opposing shell outsides 38 of the shell body 12, an inner width IB, which, extending along BR, is defined as the maximum distance between the opposing shell insides 26 of the shell body 12 at the two cheek regions of the face mask 10, and has an outer width ÄB, which, extending along BR, is defined as the maximum distance between the opposing shell outsides 38 of the shell body 12 at the two cheek regions of the face mask 10. In this case, the heights IH and ÄH and the widths IB and ÄB can be designed according to the head size and face shape of a user of the face mask. Thus, for example, IH can be between 5 and 20 cm, preferably between 7 and 13 cm.

In FIG. 2, the face mask according to the invention comprises two breathing channels 28, including respective inner openings 30 and outer openings 32. Here, the two breathing channels 28 are illustrated by the associated openings 30, 32, reference being made to FIG. 3 for the complete course of the breathing channels 28. The number, the size, and the position of the breathing channels 28, as well as their openings 30, 32, are by way of example and can be varied accordingly. In this case, the arrangement shown here of the inner openings 30 on the shell inside is particularly preferred, since, on account of the symmetrical positioning of the inner openings 30 on the left-hand side or right-hand side of the mouth region of the user, at the height of the inner width IB, the produced vocal sound does not enter the two inner openings 30 directly, and a particularly preferred flow course of the breathing air can be produced. In addition, such an arrangement can have an advantageous effect on the breathing resistance, and can produce a reduction in murmurs. The outer openings 32 are arranged adjacently to one another in FIG. 2, in a lower edge region of the face mask 10, and are open in the direction of the shell outside (not shown in FIG. 2). Via the two openings 30, 32, air can circulate through a breathing channel 28, the breathing channels 28 being designed such that the user of the face mask 10 can breathe in or out without significant breathing resistance. Furthermore, in FIG. 2 the connection elements 22 leading to the head support 14 and the complementary connection devices 20 are shown in part.

Moreover, the face mask 10 illustrated in FIG. 2 comprises two microphones 34, which, here, are integrated into the insulating layer 16 centrally on the shell inside 26, in order to be able to record, in high quality, the singing produced by the user of the face mask 10. Furthermore, FIG. 2 shows two connection terminals 36, which can be integrated into the shell body 12 so as to be easily accessible for the user, the number and position of the connection terminals 36 not being limited to the manner shown in FIG. 2. The connection terminals 36 can, for example, be formed as an AUX terminal, USB terminal, or in the form of an SD card receptacle, in order to couple or connect the face mask 10 to external devices and/or storage media.

FIG. 3 is a lateral cross-section of the first embodiment of the face mask 10 according to the invention, along the line A-B shown in FIG. 2. Furthermore, FIG. 3 illustrates the extension of the shell body 12 of the face mask 10 along the height direction HR and along a depth direction TR. Here, the shell body 12 has an inner depth IT, which, extending along TR, is defined as the maximum distance between the insulating layer 16 attached to the shell inside 26 and the cushioned edge region of the insulating layer 16, and has an outer depth ÄT, which, extending along TR, is defined as the maximum distance between the outer layer 18 on the shell outside 38 and the cushioned edge region of the insulating layer 16.

Furthermore, at this point the entire course of the breathing channel 28 should be explained. The breathing channel 28 extends completely from the inner opening 30, which, as shown in FIG. 2, is arranged on the shell inside 26, to the outer opening 32, which is arranged here on a lower edge region of the shell body 12, on the outer layer 18. In this case, the corresponding edge region of the shell body 12, in the state when worn, is adjacent to the neck attachment of the user of the face mask 10. The breathing channel 28 extends in particular inside the insulating layer 16 and, as shown in FIG. 4, is designed to be open, in part, towards the outer layer 18. Furthermore, the breathing channel 28 has a channel redirection 40, which is designed to quieten vocal sound penetrating into the breathing channel 28. This is achieved in particular by the changes in direction, along the course of the breathing channel 28, shown in FIG. 3, vocal sound being reflected multiple times on the inner wall of the breathing channel 28, owing to the changes in direction, and it being possible, ultimately, for a sound-insulating effect to be achieved. A first change in direction of the breathing channel 28 is produced immediately after the inner opening 30, since the breathing channel 28 follows the course of the insulating layer 16, within the insulating layer 16, and thus follows the shell shape of the shell body 12, the breathing channel 28 extending adjacently to the outer layer 18. Further changes in direction can take place in the height direction HR and/or in the width direction BR, and can for example be designed to be alternating, in order to amplify the occurring sound reflections. At this point, it is again noted that the breathing channel 28, as already described, can also produce a sound-damping effect, in addition to its sound-insulating effect by virtue of the sound-absorbing properties of the open-pored soft foam or the material at the inner wall of the breathing channel 28.

In addition to the pronounced damping and insulating effect of the breathing channel 28, this is also designed to produce the lowest possible breathing resistance, in order not to make it more difficult for the user to breath when singing and/or speaking. The breathing resistance is influenced inter alia by the volume of the breathing channel 28 and by the flow properties within the breathing channel 28.

The ON/OFF switch 24 and the connection terminals 36 are shown in FIG. 3 together with their cabling 42 or their operative connection to further electronic components within the shell body 12. In addition to the above-mentioned microphone 34, in this case in particular a combined processing and storage unit 44, a communications interface 46, and an accumulator 48, are cited. The processing and storage unit 44 is in particular designed to process and store acoustic signals recorded by the microphone 34. In FIG. 3, the electronic components are arranged by way of example in the shell body 12, the positioning thereof not being limited to this specific arrangement, for example the electronic components and their cabling 42 can also be provided in or on the outer layer 18. In particular, the processing and storage unit 44, as well as the communications interface 46, can furthermore also be capable of wirelessly receiving, processing, or storing signals, or transmitting them to external devices, for example via a Bluetooth connection. Furthermore, FIG. 3 discloses that the insulating layer 16 can be connected to the outer layer 18 via a hook and loop fastener 50, in order not to be displaced in an undesired manner during use of the face mask 10. Optionally, for this purpose, a plurality of hook and loop fasteners 50 can also be provided, it being possible for the hook and loop fasteners 50 to be distributed over the entire region of the shell body 12. Alternatively or in addition, the insulating layer 16 can also be adhesively bonded to the outer layer 18.

FIG. 4 is a plan view of a cross-section of the first embodiment of the face mask 10 according to the invention, along the line C-D shown in FIG. 3, the extension of the shell body 12 of the face mask 10 along the depth direction TR and along the width direction BR being illustrated. It is shown in particular here that the channel redirection 40 of the two breathing channels 28 for sound insulation can have changes in direction along the width direction BR. Furthermore, it can be seen from FIG. 3 and in particular from FIG. 4 that the insulating layer 16 can have an increased diameter at the edge regions of the face mask 10 or at the transition regions 52 to the user's face, i.e. in particular at the contact surfaces of the insulating layer 16, the outer layer 18 not being formed in these regions. The increased diameter makes it possible on the one hand for an increased quietening effect to be achieved, and on the other hand for the wearing comfort of the user to be increased, since said user does not come into contact with the material of the outer layer 18, which is harder compared with the acoustic insulating material of the insulating layer 16. The increased diameter of the transition regions 52 can furthermore serve as a buffer one, such that a user having a particularly wide face shape also does not come into contact with the outer layer 18 when wearing the face mask 10. Furthermore, the configuration shown makes it possible for the contact pressure produced via the head support 14 to be distributed uniformly on the face of the user of the face mask 10.

Furthermore, FIG. 4 again illustrates the central arrangement, in the width direction, of the electronic components, in particular the microphones 34, which, due to their positioning directly in front of the mouth region of the user, are capable of recording produced singing in high quality and as free of losses as possible.

With reference to FIG. 5 to 9, a second embodiment of a face mask 100 according to the invention will now be explained in the following, in this connection only the differences from the face mask 10 according to the first embodiment being discussed in detail, and reference being made, for the further features and functions of the face mask 100, to the first embodiment. In particular, some of the electronic components of the first embodiment are not shown in FIG. 5 to 9 for reasons of clarity, but can also be included in the face mask 100 according to the second embodiment.

FIG. 5 is a perspective view of the face mask 100 according to the invention, according to the second embodiment, said face mask being illustrated in the state when worn on the head or face or a user 102. The face mask 100 comprises a shell body 112 as well as connection devices 120 and connection elements 122 of a head support 114, the formation of which on the head of the user 102 being merely indicated here. With regard to the design of the head support 114 of the second embodiment, reference is therefore made at this point to the head support 14 of the first embodiment. Furthermore, FIG. 5 in particular shows an outer layer 118 of the shell body 112, which can be formed of a different material from the insulating layer (not shown here) on the shell inside of the shell body 112 that faces the face of the user 102.

As is undoubtedly clear from FIG. 5, in particular in comparison with FIG. 1, the contact surfaces of the insulating layer 116 of the second embodiment are displaced outwards, along the width direction BR, compared with the contact surfaces of the first embodiment, such that the insulating layer 116 has more contact surfaces, overall, than the insulating layer 16 of the first embodiment. This relates above all to the upper part of the shell body 112 of the face mask 100 in the vertical direction or height direction HR, which extends in FIG. 5, by way of example, on both sides, up to a respective cheekbone region 104 of the user 102. Here, the cheekbone region 104 relates in particular to the cheekbone of the user 102, but can optionally also include a temporal bone of the user 102. Accordingly, the shell body 112 of the face mask 100 can, if desired, extend even deeper in the direction towards the temporal bone of the user 102 than shown in FIG. 5, in order to also contact the temporal bone of the user 102, at least in portions. Optionally, for this purpose, the shell body 112 can also be designed to be slightly wider. In this connection, it is noted that all the features of the face mask 100 relating to the cheekbone of the user 102 can also be applicable to the temporal bone of the user 102.

As already mentioned, the insulating layer 116 of the face mask 100 comprises more contact surfaces compared with the insulating layer 16 of the face mask 10 of the first embodiment, i.e. more surfaces of the shell body 112 of the face mask 100 which directly contact the face of the user 102. Thus, a contact pressure produced by the shell body 112, which acts on the face of the user 102 when the face mask 100 is worn, can be diverted particularly efficiently to the face of the user 102. Furthermore, the contact surfaces of the face mask 100 of the second embodiment are displaced outwards along BR with respect to the center of the face, i.e. in particular with respect to the mouth, the nose and the chin of the user 102, compared with the face mask 10 of the first embodiment, such that the parts of the face required for singing or speaking are not impaired by the shell body 112, and the user 102 experiences a high degree of freedom of movement in this connection.

FIG. 5 furthermore illustrates that the face mask 100 comprises a substantially horizontally extending upper edge 106 on its upper side, along BR. In this case, the upper edge 106 terminates the shell body 112 or the outer layer 118 of the shell body at the transition region 152 between the face mask 100 and the face of the user 102. The face mask 100 is designed in such a way that the upper edge 106 is arranged below the eyes of the user 102, such that the vision of the user 102 is not impaired by the face mask 100.

FIG. 6 now shows a side view of the face mask 100 in the state when worn. It follows from this view, inter alia, that the shell body 112, analogously to the shell body 12 of the first embodiment, comprises an insulating layer 116 which is formed on the shell inside of the shell body 112 and comprises an acoustic insulating material. In this case, the insulating layer 116, also analogously to the first embodiment, protrudes slightly beyond the outer layer 118 in the transition region 152 along the depth direction TR between the shell body 112 and the face of the user 102, and can have a larger diameter or a greater thickness in this region, along the width direction BR, than in the region of the insulating layer 116 that is covered by the outer layer 118.

As already mentioned, on account of the head support 114 a contact force or a contact pressure FA of the shell body 112 can be transmitted from the face mask 100 to the face of the user 102 via contact surfaces. As illustrated schematically in FIG. 6, the contact pressure FA of the shell body 112 can be generated on both sides of the face mask 100, in each case via an upper connection element 122a of the head support 114, while a lower connection element 122b substantially ensures that the shell body 112 is secured in its position along the depth direction TR, and the shell body 112 thus rests tightly on the face of the user 102 when the face mask 100 is worn.

Furthermore, the head support 114 also acts counter to the weight force FG of the face mask 100, such that said mask is fixed, when worn, with respect to its position along the height direction HR. The arrangement of the upper and lower connection devices 120a, 120b, which hold the connection elements 122, 122a, 122b on the shell body 112, is shown merely by way of example in FIGS. 5 and 6. It is therefore also conceivable that in particular the upper connection devices 120a are formed closer to the center of gravity S of the shell body 112, in order to be able to prevent, by means of correspondingly longer connection elements 122a, a lever arm being created, which, in conjunction with the weight force FG of the face mask 100, results in an undesired torque, as a result of which the shell body 112 could fold away from the face of the user 102.

FIGS. 7, 8 and 9 show the shell body 112 of the face mask 100 in isolation, i.e. without the head support 114 and without showing the user 102. FIG. 7 is, in this connection, a rear view of the shell body 112, which in particular shows the insulating layer 116 on the shell inside 126 in detail. For example two microphones 134 can be arranged on the shell inside 126, which microphones are designed to record the user's singing. Here, the insulating layer 116 furthermore comprises two breathing channels 128, which each extend from an inner opening 130 to an outer opening 132 on a shell outside 138, and are designed to simplify breathing for the user when wearing the mask. The breathing channels 128 of the second embodiment are in particular designed identically to the breathing channels 28 of the first embodiment, and therefore reference is made, with regard to their features, function, and advantages, to the first embodiment, with reference to FIG. 1 to 4.

The shell body 112 of the face mask 100 has an inner height IH and an outer height ÄH in the height direction HR, and an inner width IB and an outer width ÄB in the width direction BR. As shown in FIG. 7, IH extends between the chin region and the nose region of the insulating layer 116, while ÄH along HR represents the maximum extension of the shell body 112. Analogously to IH, IB extends between the two cheek regions of the insulating layer 116. AB, in contrast, represents the maximum extension of the shell body along BR.

It furthermore follows from FIG. 7 that two support portions 108 are formed at edge regions of the shell body 112, which support portions are, here, arranged symmetrically to one another with respect to a plane of symmetry extending along HR through the center of the shell body 112. In other words, a support portion 108 can be provided in each case, both on a left-hand edge region and on a right-hand edge region of the insulating layer 116. The support portions 108 serve as a contact surface and thus divert the contact pressure of the shell body 112 to the user's face. Since the two support portions 108 are, here, included in the insulating layer 116, said portions can consequently consist of the same material, in particular a flexible soft foam, which is easily deformable. The support portions 108 preferably have a greater diameter or a greater thickness along BR than the adjacent regions of the insulating layer 116, such that the two support portions 108 can transmit the majority of the contact pressure to the user's face. Since, in the state when worn, the two support portions 108 are in each case aligned with a cheekbone region of the user (not shown in FIG. 7), i.e. the support portions 108 can rest on the cheekbone region when the face mask 100 is worn, the contact pressure is consequently diverted to precisely this cheekbone region. This is advantageous in particular when singing, since the cheekbone, included in the cheekbone region, and optionally the temporal bone of the user, are not needed or needed only to a small extend during this activity, and the transmission of the contact pressure to the cheekbone region therefore does not constitute any impairment for the user. Rather, as a result, the parts of the face required for singing, speaking, and breathing, in particular the mouth, jaw, nose, and the muscles formed in the cheek region, are relieved, as a result of which greater freedom of movement of these face parts during singing is ensured.

Furthermore, the transmission of the contact pressure can be concentrated on the support portions 108, in that these have a greater stiffness compared with the other contact surfaces of the insulating layer 116. An increased stiffness of the support portions 108 can for example be achieved in that a region of the outer layer 118 adjacent to a support portion 108 can be formed curved, such that the force absorption is focused on this curved region. This will be explained in detail in the following, with reference to FIGS. 8 and 9. The support portions 108 can furthermore be provided at least in part of a stiffer or harder material than the other contact surfaces of the insulating layer 116. In addition, the contact surface of the support portions 108 can be enlarged over a surface that is as flat or smooth as possible, such that, in the state when worn, in particular the center of the support portions 108 rests completely on the user's cheekbone region. Thus, planar contact with the cheekbone region is made possible via the support portions 108, in which for example 1 cm² of the surface of a support portion 108 covers 1 cm² of face surface. In comparison therewith, in the case of other contact surfaces of the insulating layer 116 it can be provided that 0.2 to 0.6 cm² of the surface of a respective contact surface contacts 1 cm² of face surface. Furthermore, a support portion 108 can cover between 0.5 and 8 cm², preferably between 1 and 4 cm², of a cheekbone. In the case of a shell body 112 which contacts the user's temporal bone, a support portion 108 can cover up to 30 cm², preferably up to 20 cm², of the temporal bone.

It furthermore follows from FIG. 7 that the upper edge 106 of the shell body 112 is delimited along BR by the two support portions 108. In this case, the upper edge 106 extends substantially horizontally between the two support portions 108, but is formed curved or domed in the nose region, along the depth direction TR, in order to recreate the shape of the user's nose.

A further inventive feature of the face mask 100 of the second embodiment is the formation of at least one sealing lip 154 on the shell inside 126 of the shell body 112. The sealing lip 154, which is designed in FIG. 7 in the form of a pair of first sealing lips 154a and in the form of second sealing lips 154b, fulfils in particular three functions:

On the one hand, a sealing lip 154 can be used for limiting or reducing the cavity volume of the shell body 126, while the sealing lip 154 can on the other hand contribute to the sound-insulating effect of the face mask 100, and finally can also serve as a contact surface of the insulating layer 116. The first serves in particular to prevent the occurrence of shallow breathing. For this purpose, sealing lips 154 can be provided at different points on the insulating layer 116, such that the cavity volume can be reduced to a desired value. Thus, additional sealing lips 154 can be formed for example also in the region of the microphones 134, in particular in order to optimize the propagation of the vocal sound, produced when singing, with respect to the microphones 134, and/or in the region of the chin or the jaw.

As illustrated in FIG. 7 and FIG. 8, which is a perspective view of the shell body 112 of the face mask 100, the sealing lips 154, 154a, 154b can be included in the insulating layer 116, and thus also be produced from the acoustic insulating material. Thus, the vocal sound produced when singing is also quietened by the sealing lips 154, 154a, 154b, and additionally impeded from propagating within the cavity volume of the shell body 112. In this connection, it should also be mentioned that all the sealing lips 154 can comprise a sound-absorbing surface, as a result of which a sound-damping effect can also be produced on the basis of the sealing lips 154, in addition to their sound-insulating properties.

It furthermore follows from FIGS. 7 and 8 that the sealing lips 154, 154a, 154b are designed such that, in the worn state, they can extend from the insulating layer 116 in the direction towards the user's face. In this case, the sealing lips 154, 154a, 154b are preferably designed to contact the user's face, as a result of which the sealing lips 154, 154a, 154b represent a contact surface of the insulating layer 116. The sealing lips 154, 154a, 154b are relatively thin here, i.e. in particular only a few mm thick, and can additionally be rounded at their respective free ends, in order to be able to deform easily and thus be easily adaptable to the user's face shape when the face mask 100 is worn. Consequently, the contact pressure of the shell body 112 is diverted to the user's face, via the sealing lips 154, only slightly, as a result of which the parts of the face relevant for singing and breathing are not impaired in the immediate surroundings of the sealing lips 154.

The formation of the sealing lips 154, 154a, 154b in the region of the cheeks, jaw and nose can furthermore produce a tight termination, in terms of surface area, with the user's face, which improves the sound-insulating properties of the face mask 100. At this point, it is noted again that the formation of the sealing lips 154, 154a, 154b is not limited to the configuration shown in FIGS. 7 and 8, but rather, instead, alternative, or additional sealing lips 154 can be formed on the shell inside 126.

It also follows from FIGS. 7 and 8 that a free portion 156 can be arranged immediately adjacently to a sealing lip 154, in particular between a support portion 108 and a sealing lip 154. The free portion 156 is provided such that it does not touch or only slightly touches the user's face in the worn state of the face mask 100. The formation of a free portion 156 adjacently to a sealing lip 154 thus prevents an undesired enlargement of the contact surfaces of the insulating layer. Although particularly large contact surfaces have a positive effect on the transmission of the contact pressure, they on the one hand reduce the freedom of movement of the parts of the face relevant for singing and breathing, and on the other hand also generate pronounced static friction between the insulating layer 116 and the user's face, which impairs the displaceability or movability of the shell body 112 relative to the user's face. For example it may therefore be necessary, in particular when signing, to open the mouth wide, as a result of which the jaw pushes downwards on the insulating layer 116 along HR. If, in this connection, the shell body 112 is not displaceable along HR, at least for a few mm, for example on account of too much static friction, the user would be influenced in an undesired manner, by the face mask 100, when singing and breathing. The formation of one or more free portions 156, in combination with the sealing lips 154, 154a, 154b and the support portions 108, can therefore optimize the effect of the contact surface of the insulating layer 116, without in the process restricting the freedom of movement of relevant face parts and creating too much static friction.

With regard to the displaceability of the shell body 112 along HR, reference is made at this point to FIG. 8, which illustrates the above-mentioned flat surface of the support portion 108. Said flat surface allows the shell body 112 to slide along HR, such that the user can displace the face mask 100 relatively easily even when singing, in particular by jaw movements. In this respect, the shell body 112 comprises a recess 158 of the outer layer 118 in the region of the nose, as a result of which, in the worn state, the bridge of the user's nose does not rest directly on the outer layer 118, which is harder compared with the insulating layer 116. The same applies for the entire region of the upper edge 106, and the remaining contact surfaces of the insulating layer 116, on which the insulating layer 116 protrudes slightly beyond the outer layer 118, along TR. In particular the parts of the face which protrude into the shell body 112 when the face mask 100 is worn, i.e. in particular the jaw and the nose of the user, thus advantageously do not come into contact with the harder outer layer 118, as a result of which on the one hand the wearing comfort for the user is increased, and on the other hand the displaceability of the shell body relative to the user's face is improved. In addition, the acoustic insulating material of the insulating layer 116 can be relatively easily deformable, such that it is possible to displace the shell body 112 along HR and/or BR by a few mm and deform the acoustic insulating material in the process.

The free portions 156 shown in FIGS. 7 and 8 can optionally be provided with sealing lips 154 at least in part, for example with horizontally arranged sealing lips according to the sealing lips 154b. An arrangement of this kind can be expedient in particular if the sound-insulating properties of the face mask 100 are intended to be increased. Alternatively, it is also conceivable for at least one sealing lip 154, 154a, 154b to be formed instead of one or more free portions 156. If neither a sealing lip 154 nor a free portion 156 are intended to be formed in the regions of the free portions 156 shown in FIGS. 7 and 8, then instead a continuous contact surface of the insulating layer 116 can be arranged, which is in particular designed to be complementary to the adjacent support portion 108.

The face mask 100 of the second embodiment is shown in a plan view in FIG. 9. In this case, it can be seen inter alia that the insulating layer 116, including the two support portions 108, protrudes from the outer layer 118 in the direction towards the user's face, in the depth direction TR. In the region of the two support portions 108, the insulating layer 116 is designed to be curved inwards, relative to the width direction BR, in order to create a termination that is as planar as possible, and thus tight, on the cheekbone region of the user. Furthermore, FIG. 9 again shows that the outer layer 118 comprises the recess 158 on the upper edge 106 in the nose region and is thereby formed curved or domed. In this region, the two sealing lips 154b surround the bridge of the user's nose, such that the outer layer 118 does not come into direct contact with the user's nose or the bridge of their nose. Consequently, when wearing the face mask 100 the user contacts merely the soft, deformable insulating layer 116 of the shell body, as a result of which the face mask 100 has pronounced wearing comfort and is displaceable relative to the user's face along the height direction HR and along the width direction BR.

As already mentioned, the outer layer 118 can have a curvature 160 in a region adjacent to a support portion 108, which curvature is illustrated in FIGS. 8 and 9. In this case, it can be seen in particular from the plan view of FIG. 9 that the outer layer 118 is curved or domed inwards, i.e. in the direction of the cavity of the shell body 112, with respect to BR, in these regions.

The extension of the insulating layer 116, in the region of the support portions 108, along TR is therefore limited on account of the inwardly curved outer layer 118, the remaining contact surfaces of the insulating layer 116 not experiencing any such limitation along TR. The outer layer 118, which is harder and stiffer compared with the insulating layer 116, presses on a support portion 108 in the region of a respective curvature 160, along TR, such that a resistance acting on the support portions 108 is produced via the curvatures 160 of the outer layer 118. This results in greater stiffness of the two support portions 108, and focusing of the force absorption of the contact pressure or the contact force of the shell body 112, when the face mask 100 is worn, in the region of the support portions 108.

1. Face mask for quietening vocal sound, comprising:
a head support for fixing the face mask to the head of a user; and
a shell body which is formed in a shell shape in such a way that it can be attached over the mouth and nose region of a user, the shell body comprising at least one insulating layer which follows the shell shape and consists of an acoustic insulating material,
the shell body comprising at least one breathing channel which extends from an inner opening on a shell inside facing the user, to an outer opening on a shell outside,
wherein the breathing channel extends substantially inside the insulating layer in parallel with the course of the shell shape.

2. Face mask according to claim 1, wherein the breathing channel comprises at least one channel redirection, which, in addition to a change in direction specified by the shell shape, has at least one further change in direction.

3. Face mask according to claim 2, wherein the at least one channel redirection of the breathing channel has two alternating changes in direction.

4. Face mask for quietening vocal sound, comprising:
a head support for fixing the face mask to the head of a user; and
a shell body which is formed in a shell shape in such a way that it can be attached over the mouth and nose region of a user, the shell body comprising at least one insulating layer which follows the shell shape and consists of an acoustic insulating material,
the shell body comprising at least one breathing channel which extends from an inner opening on a shell inside facing the user, to an outer opening on a shell outside,
wherein at least one support portion is formed on an edge region of the shell body, which support portion contacts a cheekbone region of the user when the face mask is worn, such that a contact pressure of the face mask can be diverted to the user via the support portion.

5. Face mask according to claim 4, wherein two support portions are formed on the shell body, which support portions are arranged symmetrically to one another with respect to a plane of symmetry extending vertically through the face mask.

6. Face mask according to claim 5, wherein the shell body of the face mask comprises a substantially horizontally extending upper edge, which is delimited along the main extension direction thereof by the two support portions.

7. Face mask according to claim 4, wherein the support portion is designed in such a way that the face mask can be displaced vertically, relative to the user's cheekbone region, when worn.

8. Face mask according to claim 4, wherein the support portion is surrounded by the insulating layer, the support portion having a greater stiffness and/or a greater thickness than regions of the insulating layer neighboring the support portion.

9. Face mask for quietening vocal sound, comprising:
a head support for fixing the face mask to the head of a user; and
a shell body which is formed in a shell shape in such a way that it can be attached over the mouth and nose region of a user, the shell body comprising at least one insulating layer which follows the shell shape and consists of an acoustic insulating material,
the shell body comprising at least one breathing channel which extends from an inner opening on a shell inside facing the user, to an outer opening on a shell outside,
wherein at least one sealing lip is arranged on the shell inside.

10. Face mask according to claim 9, wherein the sealing lip is designed in such a way that it contacts the user's face when the face mask is worn.

11. Face mask according to claim 9, wherein the sealing lip is encompassed by the insulating layer.

12. Face mask according to claim 9, wherein at least one free portion of the acoustic insulating material is formed adjacently to the sealing lip, which free portion is spaced apart from the user's face when the face mask is worn.

13. Face mask according to claim 9, wherein at least one sealing lip is arranged so as to extend substantially horizontally, on the shell inside, and contacts the user's nose when the face mask is worn, and/or in that at least one sealing lip is arranged so as to extend substantially vertically, on the shell inside.

14. Face mask according to claim 1, wherein the acoustic insulating material comprises a sound-absorbing surface in the region of an inner wall of the breathing channel.

15. Face mask according to claim 1, wherein the inner opening is arranged adjacently to a mouth region of the user of the face mask, and the outer opening is arranged adjacently to a chin region, a cheek region, or a nose region of the user of the face mask.

16. Face mask according to claim 15, wherein the inner opening is arranged so as to be horizontally offset with respect to the mouth region of the user of the face mask.

17. Face mask according to claim 1, wherein the outer opening is arranged on an edge region of the shell body.

18. Face mask according to claim 1, wherein the face mask comprises a plurality of breathing channels.

19. Face mask according to claim 18, wherein one inner opening in each case and one breathing channel in each case is arranged horizontally on either side, with respect to the mouth region of the user.

20. Face mask according to claim 1, wherein the face mask comprises an outer layer which is formed of a different material from the insulating layer.

21. Face mask according to claim 1, wherein the face mask comprises at least one microphone.

22. Face mask according to claim 1, wherein the face mask comprises headphones or can be connected to external headphones, and in that the face mask comprises at least one processing unit for processing acoustic signals.

23. Face mask according to claim 1, wherein the face mask further comprises at least one sound-insulating device, which is provided at the ear regions of the user and is designed to insulate external acoustic signals.

24. Face mask according to claim 1, wherein the face mask has a width (IB) at its shell inside which corresponds to 0.5 to 1.3 times an inner height (IH) of the shell body of the face mask, and in that the face mask has a width (ÄB) at its shell outside which corresponds to 0.75 to 1.95 times, the inner height (IH) of the shell body of the face mask.

25. Face mask according to claim 1, wherein the face mask has a cavity volume which is less than 230 cm³.

26. Face mask according to claim 1, wherein the face mask has an inhalation resistance of less than 1.2 mbar, and has an exhalation resistance of less than 1.7 mbar.
